(19) United States
(12) Patent Application Publication
(10) Pub. No.: US 2026/0186168 A1
(43) Pub. Date: Jul. 2, 2026

(54) NEAR-EYE DISPLAY MODULE WITH METASURFACE STRUCTURE

(71) Applicant: National Yang Ming Chiao Tung University, Hsinchu City (TW)

(72) Inventors: Peichen YU, Hsinchu City (TW); Chuanen LIN, Taichung City (TW); I Hsuan CHUANG, New Taipei City (TW); Wenteng LIANG, Kaohsiung City (TW)

(21) Appl. No.: 19/243,693

(22) Filed: Jun. 20, 2025

(30) Foreign Application Priority Data
Dec. 27, 2024 (TW) 113151337

(51) Int. Cl. G02B 1/00; G02B 27/01

(52) U.S. Cl. CPC G02B 1/002; G02B 27/0172; G02B 2027/0123; G02B 2027/0178

(57) ABSTRACT

A near-eye display module with metasurface structures includes a transparent substrate, a light incouple-outcouple structure and at least a metasurface structure. The light incouple-outcouple structure is located on a first surface of the transparent substrate. The metasurface structure is located on the first surface of the transparent substrate, in which the metasurface structure is configured for focusing or for two-dimensional exit pupil expansion, the metasurface structure comprises a plurality of metaatoms having a columnar structure, and a specific dimension of a cross-section or a diameter of each of the metaatoms change one-by-one along a specific direction of the metasurface structure.

### RELATED APPLICATIONS

This application claims priority to Taiwan Application Serial Number 113151337, filed Dec. 27, 2024, which is herein incorporated by reference.

### BACKGROUND

### Field of Invention

The present disclosure relates to a near-eye display module with metasurface structures.

### Description of Related Art

The integrated system of an augmented reality glasses is mainly composed of three parts, which is the optical display module (such as organic light-emitting diode(OLED), micro light-emitting diode (μLED)), the sensing module (such as eye tracking) and the imaging module (such as reflective waveguide or diffractive waveguide). To ensure the comfort when be worn, the volume and the weight of each of the module must be sufficiently small to make the total weight of the glasses is sufficiently light. However, when integrating the three modules mentioned above, a collimating lens is needed to guide the image of the display module into the imaging module, which has the risk of adding weight.

The diffractive waveguide becomes the first choice of the imaging module for its thinness, large field of view and comfort when wearing. Diffractive waveguide can couple, transmit and emit light effectively. However, chromatic aberration and poor efficiency are two enormous challenges that the diffractive waveguide cannot avoid currently. Since the diffractive waveguide has a large selectivity for different wavelengths of light, it is often needed to stack multiple waveguides to avoid the phenomenon, which make it a serious challenge in lightweight design.

In virtual reality (VR) and augmented reality (AR), vergence-accommodation conflict (VAC) is often mentioned. It is a common visual problem that makes the users feels eyestrain, headache or even dizziness. In short, such problem is mainly cause by the reason that the focus of the eyes cannot be adjusted naturally as in real world when viewing contents of VR or AR.

There are two important functions of our eyes in real world, which are vergence and adjustment. When we see a near object, our eyes rotate inward (vergence) and our crystalline lens change shape simultaneously to clearly focus (adjustment). Since these two actions is performed simultaneously, we can easily see objects. However, in VR or AR, although the objects we see seems like to be at different distances, but the distance of the screen is actually unchanged, which causes the incoordination of the vergence and the adjustment of our eyes, which results in the fatigues and discomfort of our eyes.

### SUMMARY

One aspect of the present disclosure provides a near-eye display module with metasurface structure.

According to one embodiment of the present disclosure, a near-eye display module with metasurface structure includes a transparent substrate, a light incouple-outcouple structure and at least a metasurface structure. The light incouple-outcouple structure is located on a first surface of the transparent substrate. The metasurface structure is located on the first surface of the transparent substrate, in which the metasurface structure is configured for focusing or for two-dimensional exit pupil expansion, the metasurface structure includes a plurality of metaatoms having a columnar structure, and a specific dimension of a cross-section or a diameter of each of the metaatoms change one-by-one along a specific direction of the metasurface structure.

In some embodiment of the present disclosure, a lattice structure of the metasurface structure is a square lattice, a parallelogrammic lattice or a triangular lattice.

In some embodiment of the present disclosure, the light incouple-outcouple structure includes a light incouple area and a light outcouple area. The light incouple area is located on the transparent substrate. The light outcouple area is located on the transparent substrate and adjacent to the light incouple area, in which the metasurface structure is surrounded by the light outcouple area, the metasurface structure is configured for focusing, the metasurface structure has a center, the metasurface structure includes a plurality of first metaatoms, and a first diameter of each of the first metaatoms changes one-by-one along a direction from a peripheral of the metasurface structure toward the center of the metasurface structure.

In some embodiment of the present disclosure, the near-eye display module with metasurface structures further includes a grating. The grating is located on a second surface of the transparent substrate, in which the second surface faces away the first surface.

In some embodiment of the present disclosure, the near-eye display module with metasurface structures further includes a grating substrate and an optical adhesive layer. The grating substrate is located between the transparent substrate and the grating. The optical adhesive layer is located between the transparent substrate and the grating substrate.

In some embodiment of the present disclosure, the first diameter of each of the first metaatoms changes one-by-one along the direction from the peripheral of the metasurface structure toward the center of the metasurface structure by a phase.

In some embodiment of the present disclosure, the first diameter of each of the first metaatoms is in a range of 0.2 times to 0.8 times of a lattice constant of the transparent substrate.

In some embodiment of the present disclosure, a plurality of metasurface structures is provided, and the metasurfaces forms a metasurface array along a light propagating direction.

In some embodiment of the present disclosure, the light incouple-outcouple structure includes a light incouple area and a light outcouple area. The light incouple area is located on the transparent substrate. The light outcouple area is located on the transparent substrate and adjacent to the light incouple area, in which the light outcouple area is a metasurface, the metasurface is configured for two-dimensional exit pupil expansion, the metasurface includes a plurality of second metaatoms, each of the second metaatoms is a cylinder or an elliptic cylinder, and a second diameter of the cylinder or a length of a long axis of the elliptic cylinder changes one-by-one along a light propagating direction, the light propagating direction points from a center of the light incouple area toward a light emitting point of the light outcouple area.

In some embodiment of the present disclosure, the second diameters or the lengths of the long axes gradually increase along the light propagating direction.

In some embodiment of the present disclosure, the second diameters or the lengths of the long axes is in a range of 0.2 times to 0.8 times of a lattice constant of the transparent substrate.

Another aspect of the present disclosure provides a near-eye display module with metasurface structure.

According to one embodiment of the present disclosure, a near-eye display module with metasurface structure includes a transparent substrate, a light incouple-outcouple structure and at least a metasurface structure. The light incouple-outcouple structure is located on a first surface of the transparent substrate, in which the light incouple-outcouple structure includes a light incouple area and a light outcouple area. The light incouple area is located on the transparent substrate. The light outcouple area is located on the transparent substrate and adjacent to the light incouple area. The metasurface structure is located on the first surface of the transparent substrate, in which the metasurface structure is configured for focusing or for two-dimensional exit pupil expansion, the metasurface structure includes a plurality of metaatoms having a columnar structure, and a specific dimension of a cross-section or a diameter of each of the metaatoms change along a specific direction of the metasurface structure.

In some embodiment of the present disclosure, the specific dimension of the cross-section or the diameter of each of the metaatoms changes one-by-one along the direction from a peripheral of the metasurface structure toward the center of the metasurface structure by a phase.

In some embodiment of the present disclosure, the light outcouple area is a metasurface, the metasurface is configured for two-dimensional exit pupil expansion, the metasurface includes a plurality of second metaatoms, each of the second metaatoms is a cylinder or an elliptic cylinder, and a second diameter of the cylinder or a length of a long axis of the elliptic cylinder changes one-by-one along a light propagating direction, the light propagating direction points from a center of the light incouple area toward a light emitting point of the light outcouple area.

In some embodiment of the present disclosure, a plurality of metasurface structures is provided, and the metasurfaces forms a metasurface array along a light propagating direction.

In the aforementioned embodiments of the present disclosure, since the first diameter of each of the first metaatoms changes one-by-one along a direction from a peripheral of the metasurface structure toward the center of the metasurface structure, the metasurface structure has the function of a lens aside of the function of a grating, such that the metasurface structure can simultaneously focus a light and incouple a light, which means that the collimating lens needed for optical display module can be omitted, which brings strong competitiveness in the lightweight of the near-eye display module. At the same time, since the metasurface structure directly focus the image of the display device to the position of the pupil and then project to the retina to image on it, such that the displayed image won't cause incoordination in vergence and adjustment as the eyes adjust the focus to the object in different distance in the environment.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of a display module according to one embodiment of the present disclosure.

FIG. 2 is a cross-sectional view of the metasurface structure of FIG. 1.

FIG. 3 is a schematic view of the first metaatom of FIG. 1.

FIG. 4 is a top view of the metasurface structure according to another embodiment of the present disclosure.

FIG. 5 is a normalized phase diagram of the metasurface structure of FIG. 4.

FIG. 6 is a normalized light intensity diagram of the metasurface structure of FIG. 4 after focusing light.

FIG. 7 is a cross-sectional view of the metasurface structure according to yet another embodiment of the present disclosure.

FIG. 8 is a top view of the first surface of the metasurface structure of FIG. 7.

FIG. 9 is a top view of the second surface of the metasurface structure of FIG. 7.

FIG. 10 is a cross-sectional view of the metasurface structure according to yet another embodiment of the present disclosure.

FIG. 11 is a top view of the light incouple-outcouple structure of FIG. 1, in which the function of the metasurface is two-dimentional exit-pupil-expansion.

FIG. 12 is a top view of the light incouple-outcouple structure of FIG. 1, in which the function of the metasurface is two-dimentional exit-pupil-expansion.

FIG. 13 is a three color field-of-view diagram of the light incouple-outcouple structure of FIG. 11.

FIG. 14 is a three color light mixing diagram of the light incouple-outcouple structure of FIG. 11.

FIG. 15 is a top view of the light incouple-outcouple structure according to another embodiment of the present disclosure.

FIG. 16 is a top view of the display module according to another embodiment of the present disclosure.

FIG. 17 is a top view of the display module according to yet another embodiment of the present disclosure.

FIG. 18 is a top view of the display module according to yet another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

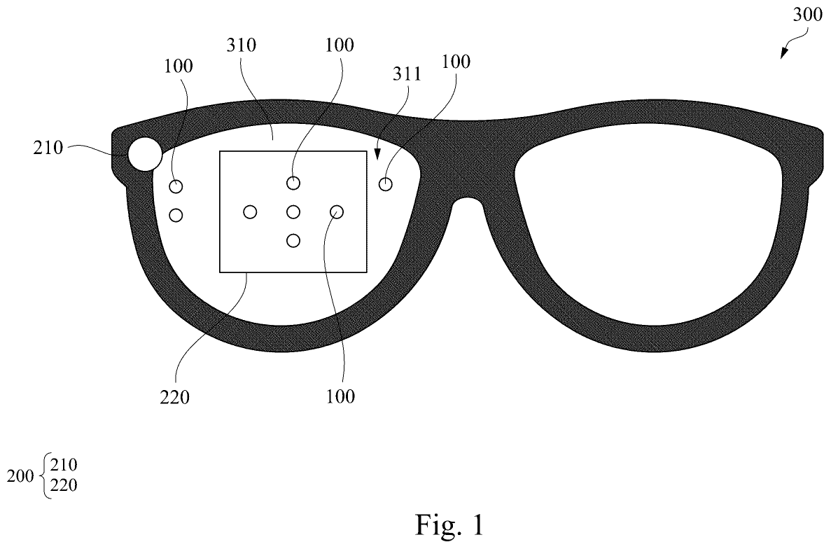

FIG. 1 is a top view of a display module 300 according to one embodiment of the present disclosure. Refer to FIG. 1, the display module 300 includes a transparent substrate 310, a light incouple-outcouple structure 200 and at least a metasurface structure 100. The light incouple-outcouple structure 200 is located on a first surface 311 of the transparent substrate 310. The metasurface structure 100 is located on the first surface 311 of the transparent substrate 310. In FIG. 1, the position and the amount of the metasurface structure 100 is merely an example, and it is not meant to limit the disclosure. The light incouple-outcouple structure 200 includes a light incouple area 210 and a light outcouple area 220. The metasurface structure 100 can locate in the light incouple area 210, in the light outcouple area 220 of out of the light incouple area 210 and the light outcouple area 220. In the following description, the metasurface structure 100 is described.

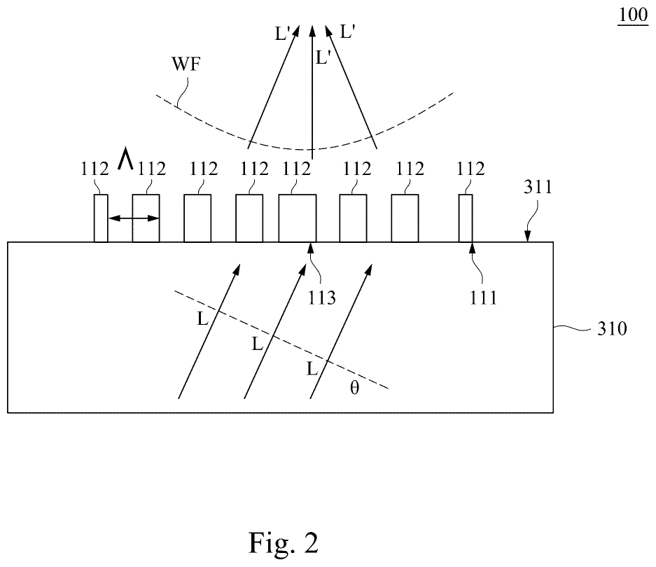

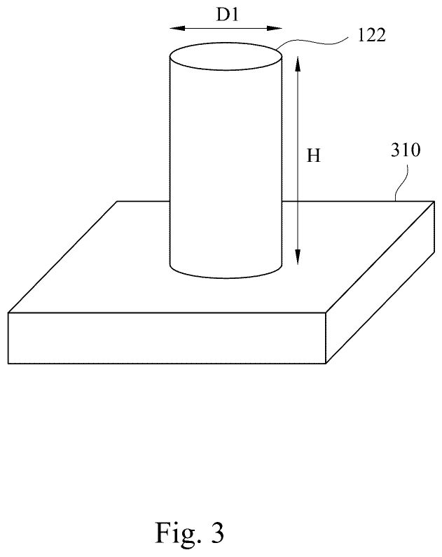

FIG. 2 is a cross-sectional view of the metasurface structure 100 of FIG. 1. FIG. 3 is a schematic view of the first metaatom 112 of FIG. 1. Refer to FIG. 2 and FIG. 3, the metasurface structure 100 has a center 113 and a peripheral 111. The metasurface structure 100 includes a plurality of first metaatoms 112. The first diameter D1 of each of the first metaatoms 112 changes along the direction from the peripheral 111 of the metasurface structure 100 towards the center 113 of the metasurface structure 100. In the present embodiment, the first diameter D1 gradually becomes greater from the peripheral 111 towards the center 113. In some embodiments, the transparent substrate can be, such as, a waveguide. Such a design can change the direction of wavefront WF of the light L when it emerge from the metasurface structure 100, which change from the original collimated light into focused light.

The material of the transparent substrate 310 can include glass. The material of the first metaatom 112 can include silicon nitride (SiNₓ), but the disclosure is not limited to these. As an example, other transparent material can also be used to manufacture the transparent substrate 310 or the first metaatom 112. In some embodiments, the height H of the first metaatom is in a range of 0.2 times of work wavelength to 1.5 times of work wavelength. In some embodiments, the lattice structure of the metasurface structure 100 is a square lattice, and the lattice constant is in a range of 0.5 times of work wavelength to 1 times of work wavelength. In some embodiments, the work wavelength can be, such as, 500 nanometer. In real manufacturing, the first metaatom 112 can be manufactured through the etching process of semiconductor process, such as steps including film deposition, photolithography, etching, but not limited to these. In real embodiments, the metasurface and the metaatom structure can enhance the mechanical strength through vapor deposition or coating dielectric film layer(s).

Since the first diameter D1 of each of the first metaatoms 112 changes one-by-one along a direction from a peripheral 111 of the metasurface structure 100 toward the center 113 of the metasurface structure 100, the metasurface structure 100 has the function of a lens aside of the function of a grating, such that the metasurface structure 100 can simultaneously focus a light and incouple a light, which means that the collimating lens needed for optical display module can be omitted, which brings strong competitiveness in the lightweight of the near-eye display module 300. At the same time, since the metasurface structure 100 directly focus the image of the display device to the position of the pupil and then project to the retina to image on it, such that the displayed image won't cause incoordination in vergence and adjustment as the eyes adjust the focus to the object in different distance in the environment.

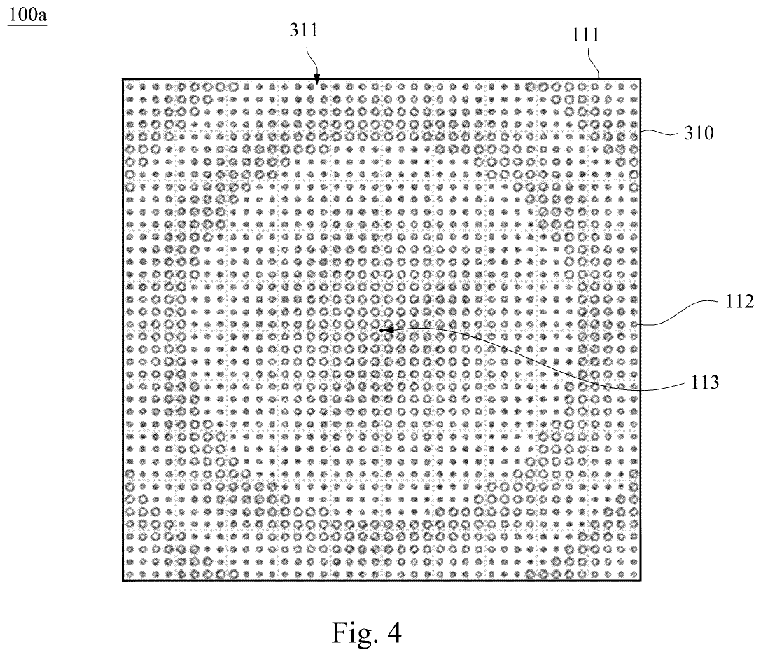

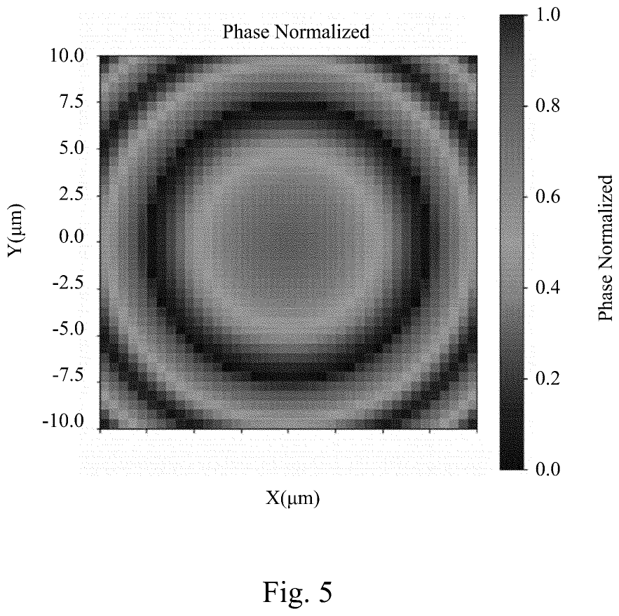

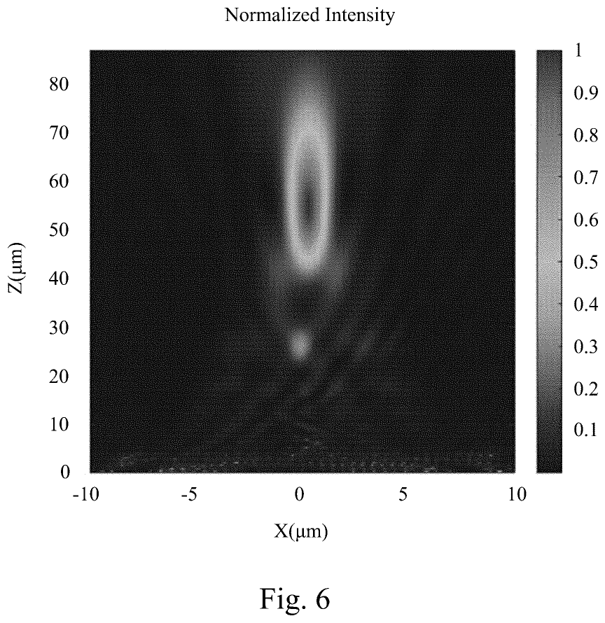

FIG. 4 is a top view of the metasurface structure 100a according to another embodiment of the present disclosure. Refer to FIG. 4, the metasurface structure 100a has a center 113 and a peripheral 111. The metasurface structure 100a includes a plurality of first metaatoms 112. The first diameter D1 (see FIG. 3) of each of the first metaatoms 112 changes along the direction from the peripheral 111 of the metasurface structure 100a towards the center 113 of the metasurface structure 100a. The difference between this embodiment and the embodiment of FIG. 2 is that, in the present embodiment, the outer contour of the metasurface structure is a square, and the first diameter D1 of each of the first metaatoms 112 changes one-by-one along the direction from the peripheral 111 of the metasurface structure 100a toward the center 113 of the metasurface structure 100a by a phase. The phase is the phase of the incident light on the metasurface structure 100a. Through choosing the work wavelength, the range of the first diameter D1 that can cover the full phase (i.e. 0 to 2π) can be obtained according to the work wavelength and the refractive index of the transparent substrate 310. In some embodiments, the first diameter D1 of each of the first metaatoms 112 is in a range of 0.2 times to 0.8 times of a lattice constant of the transparent substrate 310. FIG. 5 is a normalized phase diagram of the metasurface structure 100a of FIG. 4. It can be see that after normalization, the entire range of normalized phase is included on the metasurface structure 100a FIG. 6 is a normalized light intensity diagram of the metasurface structure 100a of FIG. 4 after focusing light, which shows the ability of focusing light of metasurface structure 100a.

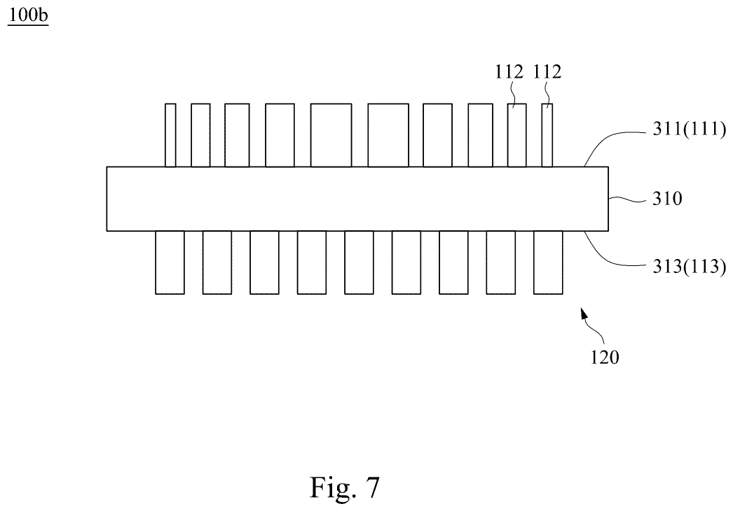

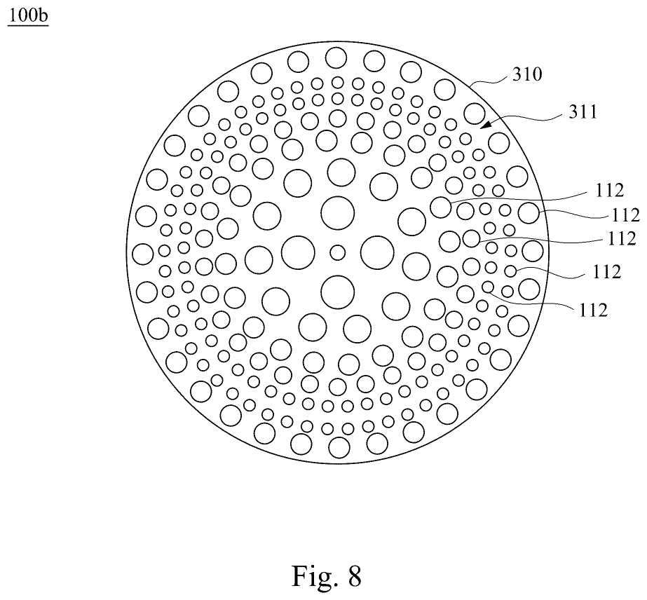

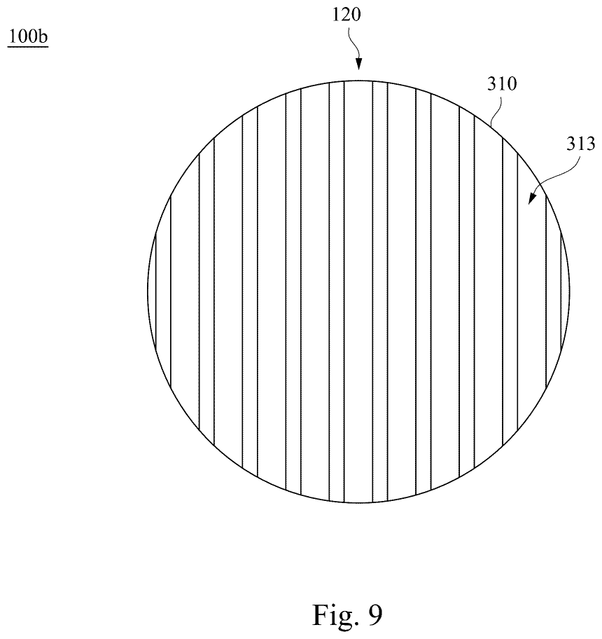

FIG. 7 is a cross-sectional view of the metasurface structure 100b according to yet another embodiment of the present disclosure. FIG. 8 is a top view of the first surface 311 of the metasurface structure 100b of FIG. 7. FIG. 9 is a top view of the second surface 313 of the metasurface structure 100b of FIG. 7. Refer to FIG. 7 to FIG. 9, the difference between the present embodiment and the embodiment of FIG. 2 is that, in the present embodiment, the metasurface structure 100b further includes a grating 120. The grating 120 is located on a second surface 313 of the transparent substrate 310, in which the second surface 313 faces away the first surface 311. Such a design can enable the first metaatom 112 of the metasurface structure 100b on the first surface 311 of the metasurface structure 100b to have the function of focusing while the grating 120 on the second surface 313 of the metasurface structure 100b to have the function of light coupling. The grating 120 can include different periodic structure according to different work wavelength and diffraction angle needed, such as binary gratings, multilevel gratings, slated gratings, but the disclosure is not limited to this.

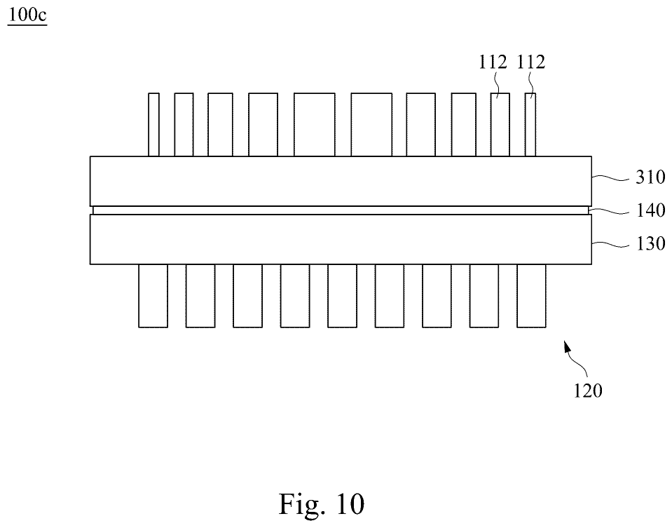

FIG. 10 is a cross-sectional view of the metasurface structure 100c according to yet another embodiment of the present disclosure. Refer to FIG. 10, the difference between the present embodiment and the embodiment of FIG. 7 is that, in the present embodiment, the metasurface structure 100c further includes a grating substrate 130 and an optical adhesive layer 140. The grating substrate 130 is located between the transparent substrate 310 and the grating 120. The optical adhesive layer 140 is located between the transparent substrate 310 and the grating substrate 130. Such a design can enables the grating 120 and the first metaatom 112 to be formed on two substrate (or two different part of a substrate), and then combine into the metasurface structure 100c through the optical adhesive layer 140.

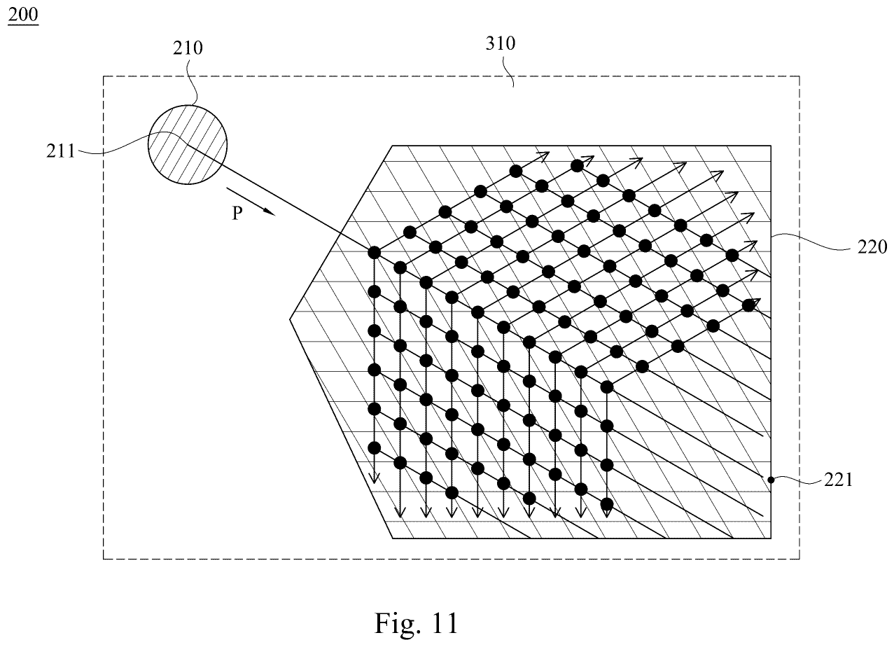

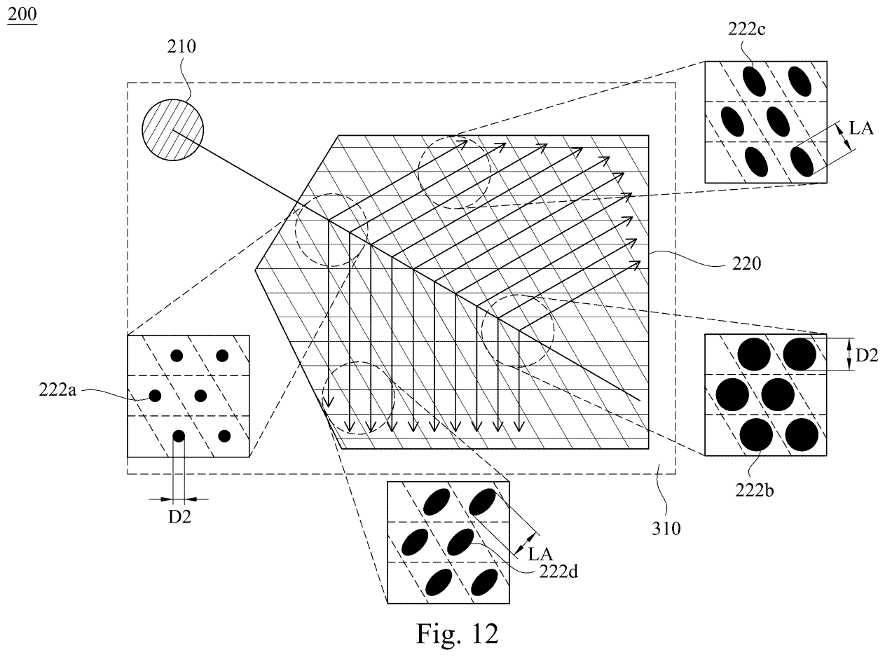

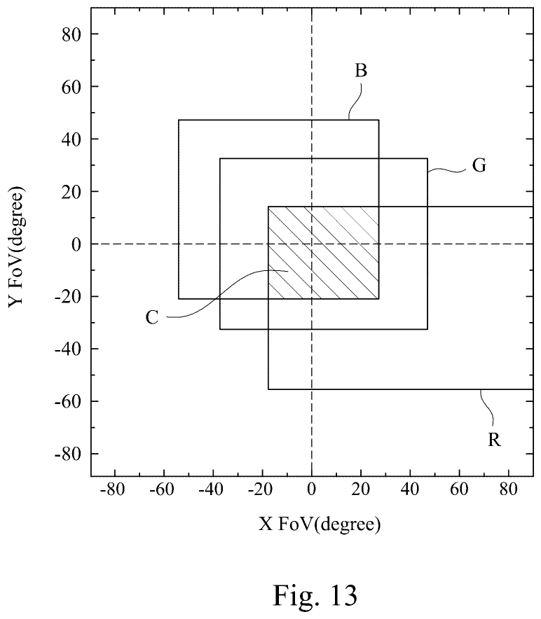

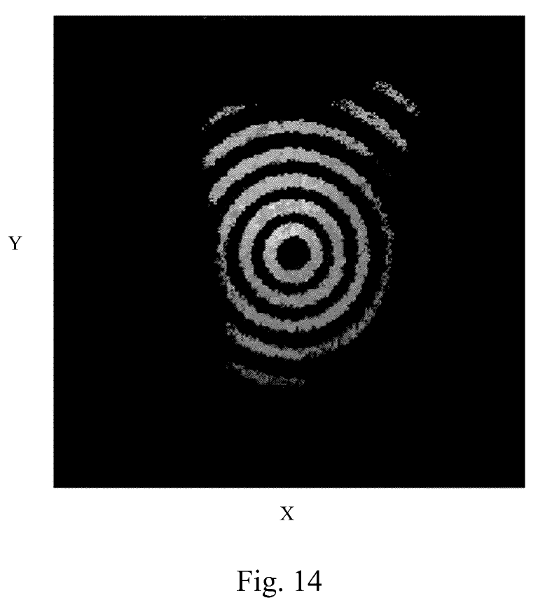

FIG. 11 is a top view of the light incouple-outcouple structure 200 of FIG. 1. FIG. 12 is a top view of the light incouple-outcouple structure 200 of FIG. 1. Refer to FIG. 11 and FIG. 12, the light incouple-outcouple structure 200 includes a light incouple area 210 and a light outcouple area 220. The light incouple area 210 is located on the transparent substrate 310. The light outcouple area 220 is located on the transparent substrate 310 and adjacent to the light incouple area 210, in which the light outcouple area 220 includes a metasurface, the metasurface is configured for two-dimensional exit pupil expansion, the lattice is a parallelogrammic lattice. the metasurface includes a plurality of second metaatoms 222a, 222b, 222c, 222d, each of the second metaatoms 222a, 222b, 222c, 222d is a cylinder (such as second metaatoms 222a, 222b) or an elliptic cylinder (such as second metaatoms 222c, 222d), and a second diameter D2 of the cylinder or a length LA of a long axis of the elliptic cylinder changes one-by-one along a light propagating direction P, the light propagating direction P points from a center 211 of the light incouple area 210 toward a light emitting point 221 of the light outcouple area 220. In the present embodiment, the second diameter D2 or the length LA of the long axis increase along the light propagating direction P. In the present embodiment, the second diameter D2 or the length LA of the long axis is in a range of 0.2 times of the lattice constant to 0.8 times of the lattice constant. Such a design adjusts the emission efficiency of the light and improves the uniformity of light emission. FIG. 13 is a three color field-of-view diagram of the light incouple-outcouple structure 200 of FIG. 11. In the diagram, R is the field of view of red light, G is the field of view of green light and B is the field of view of blue light. The range C that the three field of view overlaps is the three color filed of view of the light incouple-outcouple structure 200, which means that the light incouple-outcouple structure 200 can enlarge the field of view. FIG. 14 is a three color light mixing diagram of the light incouple-outcouple structure 200 of FIG. 11, which shows that light incouple-outcouple structure 200 can improves the problem of chromatic aberration.

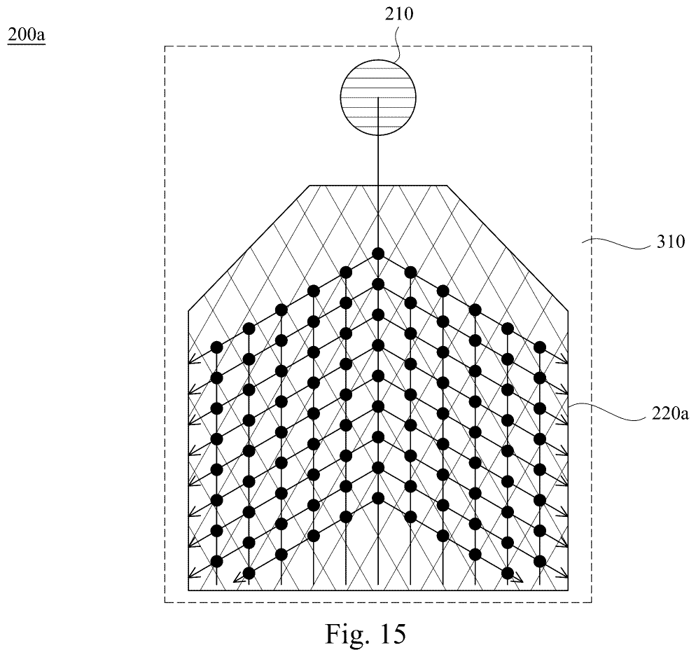

FIG. 15 is a top view of the light incouple-outcouple structure 200a according to another embodiment of the present disclosure. Refer to FIG. 15, the light incouple-outcouple structure 200a includes a light incouple area 210 and a light outcouple area 220a. The light incouple area 210 is located on the transparent substrate 310. The light outcouple area 220a is located on the transparent substrate 310 and adjacent to the light incouple area 210. The difference between the present embodiment and the embodiment of FIG. 11 is that, in the present embodiment, the light outcouple area 220a of the light incouple-outcouple structure 200a doesn't include the metasurface structure like FIG. 2 or FIG. 4, but only second metaatoms 222a, 222b, 222c, 222d of FIG. 12 is included. In some embodiments, the shape of the light outcouple area 220a can be a square, a rectangle, a polygon or a circle.

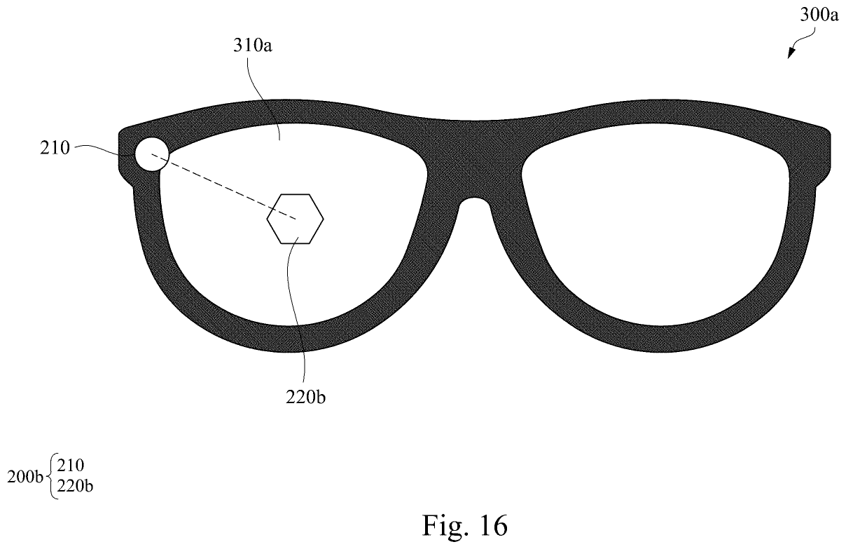

FIG. 16 is a top view of the display module 300a according to another embodiment of the present disclosure. Refer to FIG. 16, the display module 300a includes a transparent substrate 310a and a light incouple-outcouple structure 200b. The difference between the present embodiment and the embodiment of FIG. 1 is that, in the present embodiment, the structure of the light outcouple area 220b of the light incouple-outcouple structure 200b is similar to the metasurface structure 100a of the embodiment of FIG. 4. Also, the lattice structure of the metasurface structure 100a is a hexagonal lattice, therefore, the outer contour of the light outcouple area 220b is substantially a hexagon, and the connection line between the center of the light incouple area 210 and the light outcouple area 220b is perpendicular to the boarder of the light outcouple area 220b. In some embodiments, the metasurface structure can have the same characteristic of the embodiment of FIG. 4, or the same characteristic of the embodiment of FIG. 7 (metasurface structure 100b), FIG. 10 (metasurface structure 100c), but the disclosure is not limited to these.

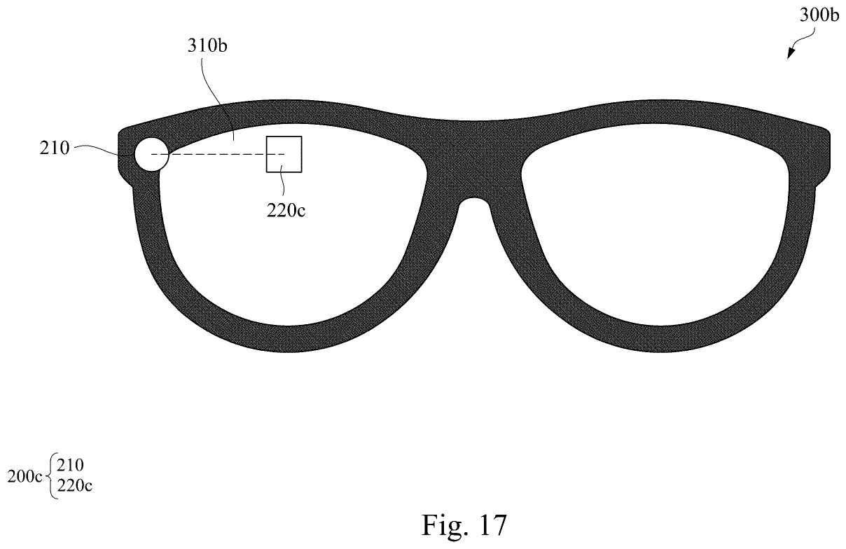

FIG. 17 is a top view of the display module 300b according to yet another embodiment of the present disclosure. Refer to FIG. 17, the display module 300b includes a transparent substrate 310b and a light incouple-outcouple structure 200c. The difference between the present embodiment and the embodiment of FIG. 1 is that, in the present embodiment, the structure of the light outcouple area 220c of the light incouple-outcouple structure 200c is similar to the metasurface structure 100a of the embodiment of FIG. 4. Also, the lattice structure of the metasurface structure 100a is a square lattice, therefore, the outer contour of the light outcouple area 220c is substantially a hexagon, and the connection line between the center of the light incouple area 210 and the light outcouple area 220c is substantially a horizontal line. In some embodiments, the metasurface structure can have the same characteristic of the embodiment of FIG. 4, or the same characteristic of the embodiment of FIG. 7 (metasurface structure 100b), FIG. 10 (metasurface structure 100c), but the disclosure is not limited to these.

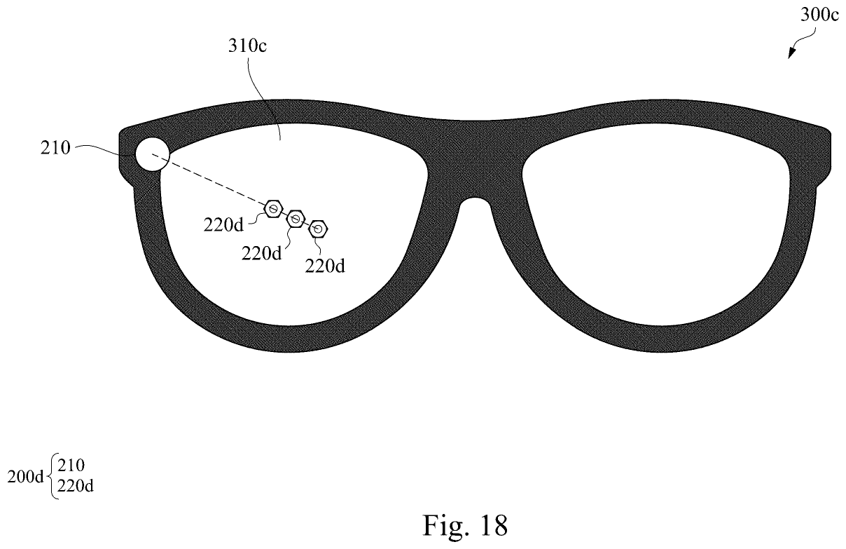

FIG. 18 is a top view of the display module 300c according to yet another embodiment of the present disclosure. Refer to FIG. 18, the display module 300c includes a transparent substrate 310c and a light incouple-outcouple structure 200d. The difference between the present embodiment and the embodiment of FIG. 1 is that, in the present embodiment, the light outcouple area 220d of the light incouple-outcouple structure 200d are a plurality of metasurface structures aligned in a row. In some embodiments, the metasurface structure can have the same characteristic of the embodiment of FIG. 4, or the same characteristic of the embodiment of FIG. 7 (metasurface structure 100b), FIG. 10 (metasurface structure 100c), but the disclosure is not limited to these.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A near-eye display module with metasurface structures, comprising:
a transparent substrate;
a light incouple-outcouple structure located on a first surface of the transparent substrate; and
at least a metasurface structure located on the first surface of the transparent substrate, wherein the metasurface structure is configured for focusing or for two-dimensional exit pupil expansion, the metasurface structure comprises a plurality of metaatoms having a columnar structure, and a specific dimension of a cross-section or a diameter of each of the metaatoms change one-by-one along a specific direction of the metasurface structure.

2. The near-eye display module with metasurface structures of claim 1, wherein a lattice structure of the metasurface structure is a square lattice, a parallelogrammic lattice or a triangular lattice.

3. The near-eye display module with metasurface structures of claim 1, wherein the light incouple-outcouple structure comprises:
a light incouple area located on the transparent substrate; and
a light outcouple area located on the transparent substrate and adjacent to the light incouple area, wherein the metasurface structure is surrounded by the light outcouple area, the metasurface structure is configured for focusing, the metasurface structure has a center, the metasurface structure comprises a plurality of first metaatoms, and a first diameter of each of the first metaatoms changes one-by-one along a direction from a peripheral of the metasurface structure toward the center of the metasurface structure.

4. The near-eye display module with metasurface structures of claim 3, further comprising:
a grating located on a second surface of the transparent substrate, wherein the second surface faces away the first surface.

5. The near-eye display module with metasurface structures of claim 4, further comprising:
a grating substrate located between the transparent substrate and the grating; and
an optical adhesive layer located between the transparent substrate and the grating substrate.

6. The near-eye display module with metasurface structures of claim 3, wherein the first diameter of each of the first metaatoms changes one-by-one along the direction from the peripheral of the metasurface structure toward the center of the metasurface structure by a phase.

7. The near-eye display module with metasurface structures of claim 3, wherein the first diameter of each of the first metaatoms is in a range of 0.2 times to 0.8 times of a lattice constant of the transparent substrate.

8. The near-eye display module with metasurface structures of claim 3, wherein a plurality of metasurface structures is provided, and the metasurfaces forms a metasurface array along a light propagating direction.

9. The near-eye display module with metasurface structures of claim 1, wherein the light incouple-outcouple structure comprises:
a light incouple area located on the transparent substrate; and
a light outcouple area located on the transparent substrate and adjacent to the light incouple area, wherein the light outcouple area is a metasurface, the metasurface is configured for two-dimensional exit pupil expansion, the metasurface comprises a plurality of second metaatoms, each of the second metaatoms is a cylinder or an elliptic cylinder, and a second diameter of the cylinder or a length of a long axis of the elliptic cylinder changes one-by-one along a light propagating direction, the light propagating direction points from a center of the light incouple area toward a light emitting point of the light outcouple area.

10. The near-eye display module with metasurface structures of claim 9, wherein the second diameters or the lengths of the long axes gradually increase along the light propagating direction.

11. The near-eye display module with metasurface structures of claim 9, wherein the second diameters or the lengths of the long axes is in a range of 0.2 times to 0.8 times of a lattice constant of the transparent substrate.

12. A near-eye display module with metasurface structures, comprising:
a transparent substrate;
a light incouple-outcouple structure located on a first surface of the transparent substrate, wherein the light incouple-outcouple structure comprises:
a light incouple area located on the transparent substrate;
a light outcouple area located on the transparent substrate and adjacent to the light incouple area; and
at least a metasurface structure located on the first surface of the transparent substrate, wherein the metasurface structure is configured for focusing or for two-dimensional exit pupil expansion, the metasurface structure comprises a plurality of metaatoms having a columnar structure, and a specific dimension of a cross-section or a diameter of each of the metaatoms change along a specific direction of the metasurface structure.

13. The near-eye display module with metasurface structures of claim 12, wherein the specific dimension of the cross-section or the diameter of each of the metaatoms changes one-by-one along the direction from a peripheral of the metasurface structure toward the center of the metasurface structure by a phase.

14. The near-eye display module with metasurface structures of claim 12, wherein the light outcouple area is a metasurface, the metasurface is configured for two-dimensional exit pupil expansion, the metasurface comprises a plurality of second metaatoms, each of the second metaatoms is a cylinder or an elliptic cylinder, and a second diameter of the cylinder or a length of a long axis of the elliptic cylinder changes one-by-one along a light propagating direction, the light propagating direction points from a center of the light incouple area toward a light emitting point of the light outcouple area.

15. The near-eye display module with metasurface structures of claim 12, wherein a plurality of metasurface structures is provided, and the metasurfaces forms a metasurface array along a light propagating direction.
